(19) United States
(12) Patent Application Publication
(10) Pub. No.: US 2004/0168711 A1
(43) Pub. Date: Sep. 2, 2004

(54) Container rinsing apparatus and method

(75) Inventors: Thomas D. Dickson JR., Midway, UT (US); Mark W. McLane, Orem, UT (US)

Correspondence Address: L. Grant Foster, HOLLAND & HART LLP, P.O. Box 8749, Denver, CO, 80201, US

(73) Assignee: K-TEC, Inc.

(21) Appl. No.: 10/375,491

(22) Filed: Feb. 27, 2003

(51) Int. Cl. B08B 9/093

(52) U.S. Cl. 134/22.18; 134/44; 134/146; 134/148; 134/152; 134/166 R

(57) ABSTRACT

A container rinsing apparatus and method of rinsing a container that includes a nozzle positioned to spray liquid at a particular spray angle toward the interior surface of the container when the top surface of the container depresses a base cover of the rinsing apparatus. The rinsing apparatus is capable of completely rinsing virtually any shape of container without requiring manipulation of the container relative to the rinsing device during rinsing. When the container is positioned to engage the rinsing apparatus, the nozzle is closer to the open end of the container than the closed end.

### TECHNICAL FIELD

This invention relates generally to rinsing devices, and more particularly to a method and apparatus for efficiently rinsing a container for holding foodstuffs.

### BACKGROUND OF THE INVENTION

Food processors and blending machines are being used now more than ever, particularly in the high-volume, commercial beverage industry. People are increasingly becoming aware of the benefits, in terms of taste and quality, of well-processed beverages. Blended fruit smoothies and similar fruit drinks, popular with all types of people ranging from the fitness conscious to the less active, require a food processor or blending machine. Cold beverages, in particular, which utilize fruit (frozen or fresh) and ice in their preparation present unique challenges. An appropriate blending machine will break down the ice, fruit, and other ingredients in attempting to achieve an ideal uniform drink consistency. In addition, food processors or blending machines are ideal for mixing nutritional supplements into beverages while similarly attempting to achieve an ideal uniform drink consistency.

In addition to the recent increase in the popularity of smoothies, food processors and blending machines are being used to produce many new and different beverages. For example, different types of coffees, shakes, dairy drinks, and the like are now commonly served at many different types of retail business locations. Consumers are demanding more diversity and variety in the beverages available at these smoothie and other retail stores. The keys to producing a high quality beverage, irrespective of the specific type of beverage, are quality ingredients and a high quality blending machine that will quickly and efficiently blend the ingredients to produce a drink with uniform consistency.

One problem associated with businesses that depend on blending machines is the speed with which the beverage or drinks are prepared. In the food preparation industry, time equals money. One of the limiting factors in preparation speed is often the time it takes to clean the blending jar or container between various orders. Once a particular beverage is prepared in a container, the container must be thoroughly washed or rinsed before another beverage can be prepared in the same container to avoid contamination. One conventional solution to this problem has involved collecting multiple containers after they have been used at a collection location (e.g., a sink) where washing or rinsing can be deferred until numerous containers have been used. Naturally the efficiency of this solution is limited by the number of containers and the employee(s) available to clean the containers. For example, if a smoothie store had 10 containers, and a large group of people entered the store and ordered 30 individual smoothies, the employee(s) would still be forced to stop making smoothies at some point and wash out the limited number of containers. Therefore, the solution of stocking multiple containers is not an efficient way to solve the problems associated with cleaning containers between processing drinks.

A different solution to this problem has involved rinsing devices that rinse out a blender jar immediately after the jar has been used so that the employee can continue to prepare beverages. Unfortunately, all of the known prior rinsing devices include significant problems. For example, many of the rinsing devices require the jar to be manually manipulated (i.e., rotated and/or adjusted relative to the rinsing device) during rinsing in order to entirely rinse the interior of the container. If a rinsing device requires the jar to be manipulated for proper use, there is a chance that the person preparing the beverage may not sufficiently wash a jar resulting in beverage cross contamination and potentially unsatisfied customers. Likewise, the additional time required to manipulate the jar negates the point of having an automatic rinser as compared to simply rinsing the jar in a sink. In addition, known rinsers utilize a spray nozzle that is extended a distance away from a base of the rinsing device. This extended spray nozzle must, in some prior devices, engage the bottom of the jar near the location of the blade, which often damages the spray nozzle and adjacent structures. The extended spray nozzle design of prior rinsers also limits the shape of the jars or containers that can be rinsed effectively by the rinser.

In view of the foregoing, there is a need to provide a rinsing apparatus and method of rinsing that will allow jars or containers to be efficiently rinsed. There is also a need to provide a rinsing apparatus and rinsing method that will minimize the need to manipulate the container during rinsing, and reduce the time required to rinse a container. There is still further a need to develop a rinsing device that prevents the nozzle from being damaged by the blades found at the bottom of most blending jars.

### SUMMARY OF EMBODIMENTS OF THE INVENTION

The foregoing and other problems in the prior art are addressed by embodiments of the present invention, which relates to an efficient rinsing apparatus and method of rinsing that is capable of rinsing a blender jar or beverage container in less time than traditional rinsing devices. In addition, the rinsing apparatus is capable of completely rinsing almost any shape of container without requiring manipulation of the container during rinsing. The rinsing apparatus includes a nozzle that sprays liquid at a particular spray angle toward the interior surface of the container when the top surface of the container actuates the rinsing apparatus. When the container is properly positioned over the rinsing apparatus, the nozzle is closer to the open end of the container as compared to the closed end of the container. The rinsing apparatus utilizes a non-electrical actuator to switch the rinsing mechanism on and off.

One embodiment of the present invention pertains to a rinsing apparatus including a base cover and a base. The base cover extends over the base and is biased upward relative to the base. The base cover comprises a spring, a magnet, and a nozzle. The spring is configured to bias the base cover away from the base when no downward force is applied onto the base cover. The nozzle is in fluid connection with a valve incorporated into the base such that liquid flows from the nozzle at a particular spray angle into the container when the valve is in an open position. The magnet is located on the underside of the base cover such that when the base cover is depressed toward the base, the magnet exerts a magnetic force on the valve causing the valve to move into the open position. The base comprises a liquid supply line that includes an inlet. Pressurized liquid is introduced into the supply line via the inlet. Flow of liquid through the liquid supply line is regulated by the valve. The valve moves between an open position, which allows the liquid to flow out the nozzle, and a closed position, which prevents the liquid from flowing through the valve.

The rinsing apparatus of the present invention is utilized by positioning a container over the rinsing apparatus with the top surfaces or open end of the container facing down. The open end of the container engages the base cover and force is applied to overcome the spring bias and depress the cover relative to the base. The switch is actuated and pressurized liquid, such as water, is introduced into the interior of the container. The liquid then flows out of the open end of the container along the exterior of the base cover of the rinsing apparatus to a drain. The container depresses the rinsing apparatus for a period of time sufficient to entirely rinse out the container. The container is then removed from the rinsing apparatus and is ready for use in preparing another beverage.

The present invention provides numerous advantages over the prior art. Some prior art devices require the container to be manipulated during the rinsing process whereas the present invention is configured to rinse out the entire interior surface of the container without manipulation. Additional time is required to manipulate the container in certain prior art devices. In addition, some prior art devices position the nozzle and/or actuating mechanism at a location that is often obstructed and damaged by the blades located at the closed end of most blending containers. The present invention positions the nozzle and actuating mechanism toward the open end of the mixing jar or container.

The foregoing features and advantages, together with other features and advantages, of the present invention, will become more apparent when referred to the following specification, claims and accompanying drawings.

### BRIEF DESCRIPTION OF THE DRAWINGS

The present invention is described below with reference to the accompanying drawings:

FIG. 1 is a perspective view of a rinsing apparatus according to the present invention with a blending jar positioned on the rinsing apparatus;

FIG. 2 is an exploded view of the base, including the liquid supply line and the valve, of the rinsing apparatus of FIG. 1;

FIG. 3 is an exploded view of the base cover, including the nozzle and the spring;

FIG. 4 is a sectional side elevation view of the rinsing apparatus of FIG. 1 illustrating the upwardly biased position of the base cover relative to the base and the closed position of the valve;

FIG. 5 is a sectional side elevation view of the rinsing apparatus of FIG. 1 illustrating the retracted position of the base cover and open position of the valve;

FIG. 6 is a perspective view of a blender jar being rinsed by the rinsing apparatus of FIG. 1, with the blender jar being positioned in a first manner relative to the base cover to actuate the rinsing apparatus;

FIG. 7 is a perspective view of a blender jar being rinsed by the rinsing apparatus of FIG. 1, with the blender jar being positioned in a second manner relative to the base cover to actuate the rinsing apparatus; and

FIG. 8 is a perspective view of a cylindrical container being rinsed by the rinsing apparatus of FIG. 1.

### DETAILED DESCRIPTION OF THE INVENTION

Reference will now be made to the drawings to describe various embodiments of the invention. It is to be understood that the drawings are diagrammatic and schematic representations of the embodiments, and are not limiting of the present invention, nor are they necessarily drawn to scale.

The present invention relates to an efficient and effective rinsing apparatus and a method of rinsing blender jars or beverage containers. The rinsing apparatus is capable of completely rinsing virtually any shape of container without requiring manipulation of the container relative to the rinsing device during rinsing. The rinsing apparatus reduces the tine required for effective rinsing, as compared to known prior rinsing devices. The rinsing apparatus includes a nozzle that sprays liquid at a particular spray angle toward the interior surfaces of the container when the top surface or open end of the container engages and depresses a base cover of the rinsing apparatus. When the container is properly positioned over the rinsing apparatus, the nozzle is closer to the open end of the container as compared to the closed end. The rinsing apparatus utilizes a non-electrical actuator to switch the rinsing mechanism on and off. Also, while embodiments of the present invention are described in the context of a method and apparatus for rinsing a blender jar, it will be appreciated that the teachings of the present invention are applicable to other applications as well. For example, the rinsing apparatus described in the present invention could be used to rinse or wash any container.

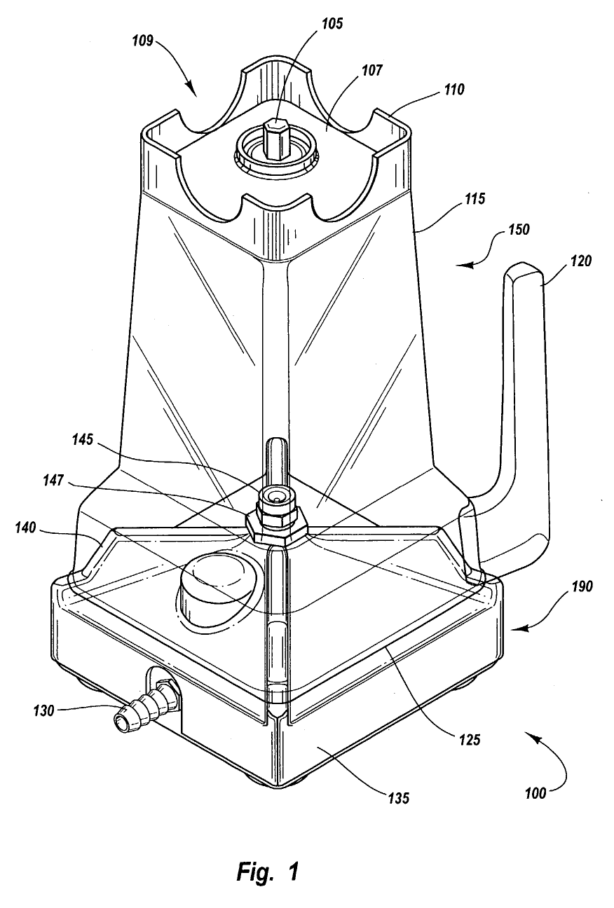

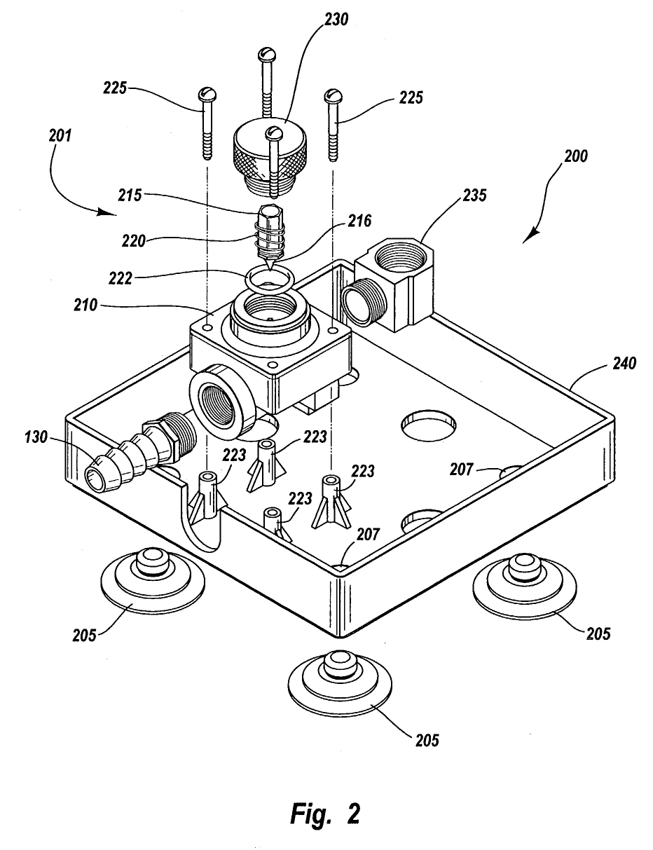

Reference is initially made to FIG. 1, which illustrates a perspective view of one embodiment of a rinsing apparatus 100 according to the present invention. The rinsing apparatus 100 comprises generally a base cover 190 (FIG. 1) and a base 200 (FIG. 2). The base cover and the base provide a housing for most of the components of the rinsing apparatus 100.

A blending jar 150 is positioned on top of the blending apparatus 100. For cleaning or rinsing purposes, the blender jar 150 is positioned upside down on top of the base cover 190 of the rinsing apparatus 100. The blender jar 150 further includes an open top surface 125, a closed bottom surface 109, sidewalls 115, and a handle 120. The blender jar 150 is configured to contain solid, liquid, or semi-solid materials when positioned right side up with the open end or top surface 125 facing up. The blender jar 150 comprises a plastic material that is both transparent and resistant to cracking. It is to be understood, however, that any suitable material understood by those skilled in the art may be used. The closed end of the jar 150 comprises a bottom surface 109 which includes an extended wall 110 surrounding the periphery of the bottom of the jar, a shaft 105 which seats inside a receiving sprocket of the blender and is attached to the blade (not shown) rotatably mounted to the jar, and a bottom wall 107. The extended wall 110 and shaft 105 interface with a blending device to facilitate the blending of materials held within the blending jar 150. The bottom wall 107 in combination with side walls 115 provide a containment area for the blending jar 150.

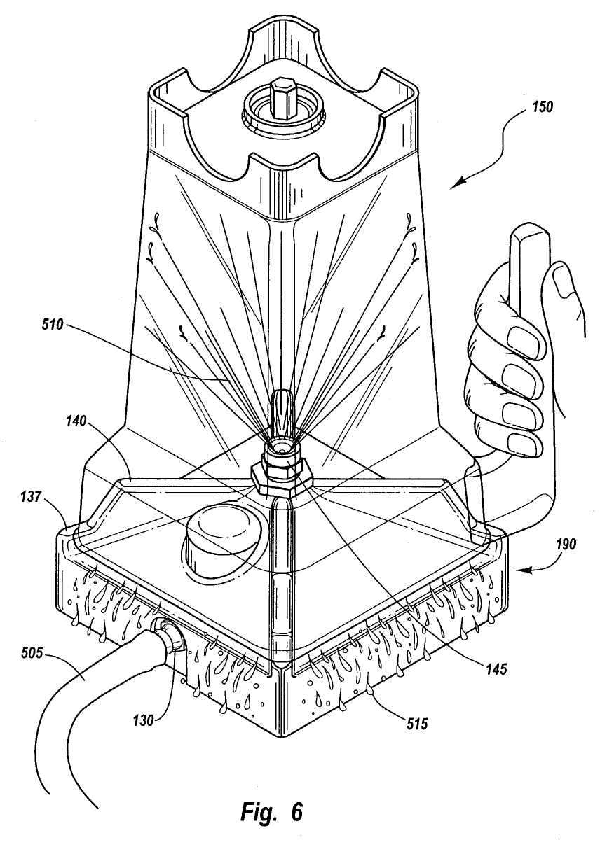

FIG. 1 shows the base cover 190 and the inlet to supply line 130. The supply line 130 allows pressurized liquid to enter the rinsing apparatus 100 for use in rinsing the jar or other container. For example, the supply line 130 can be connected to a water pipe or faucet to supply pressurized water to the rinsing apparatus 100. The base cover 190 provides the upper surfaces of the rinsing apparatus 100 that engage the top edges 125 of the blender jar 150. The base cover 190 comprises a rigid cover body 135, upstanding flanges 140, a nozzle manifold 147, and a nozzle 145. The rigid cover body 135 is composed of a plastic material that may be opaque and is resistant to cracking. It is to be understood, however, that any suitable material understood by those skilled in the art may be used. The rigid cover body 135 forms the general hollow square-like shape of the base cover 190 including an open end (facing down) and a closed end (facing up). The flanges 140 are narrow ridges or strips of plastic material that extend up from the rigid cover body 134. The flanges 140 facilitate the engagement of the rinsing apparatus 100 with various shaped containers as illustrated in FIGS. 6-8. The nozzle 145 and nozzle manifold 147 facilitate spraying of liquid, such as water or water combined with a suitable cleaning agent, into the interior of the blending jar 150 to rinse or clean the interior of the blending jar 150. The nozzle manifold 147 comprises a threaded extension piece that secures the base cover 190 to the remainder of the rinsing apparatus 100. The nozzle 145 is configured to spray the liquid at a particular three-dimensional, 360-degree spray angle inside the blender jar 150. In one embodiment, the spray angle is 120 degrees. Because the nozzle 145 is generally located near the open end of the container proximate the top edges 125 of the blending container 150 (as compared to bottom wall 107), the blending container 125 does not need to be manipulated or moved during the rinsing process in order to completely rinse the interior surface of the blending jar 150. Likewise, the blending blade (not shown) mounted to the bottom wall 109 will not substantially interfere with or obstruct the liquid sprayed by the nozzle 145.

FIG. 2 illustrates an exploded view of the base 200 illustrating the liquid supply line 130 and valve assembly 201. The base 200 comprises the lower portion of the rinsing apparatus 100 and is designed to interface with the base cover 190. The base 200 comprises a rigid base body 240 for housing a liquid supply line 130, and a valve housing 210. The supply line 130 is threadedly coupled to the valve housing 210 which is secured, in turn, to the base body 240 at mounting locations 223 extending upwardly from the base body 240. Suitable fasteners 225 are inserted through the valve housing 210 and are received at mounting locations 223 to securely hold the valve housing 210 to the base body 240.

The valve assembly 201 comprises a metal pin 215 that includes a conical point that seats inside a similarly shaped inlet opening formed in the valve housing 210 to regulate the flow of liquid through the rinsing apparatus. A coil spring 220 is secured to the outside of pin 215 to bias the pin downwardly to engage the seat when the rinsing apparatus is not in use to prevent the flow of liquid to the nozzle. A threaded cap or solenoid head 230 secures the pin and coil spring 220 inside the valve housing 210. A rubber O-ring 222 provides a seal to prevent liquid from escaping between the housing 210 and the threaded end cap 230.

To hold the rinsing device in place, such as on a countertop, a plurality of feet 205 in the form of suction cups may be provided. The suction cups 205 include upward extension portions that are received within appropriately sized apertures 207 formed in the base body 240.

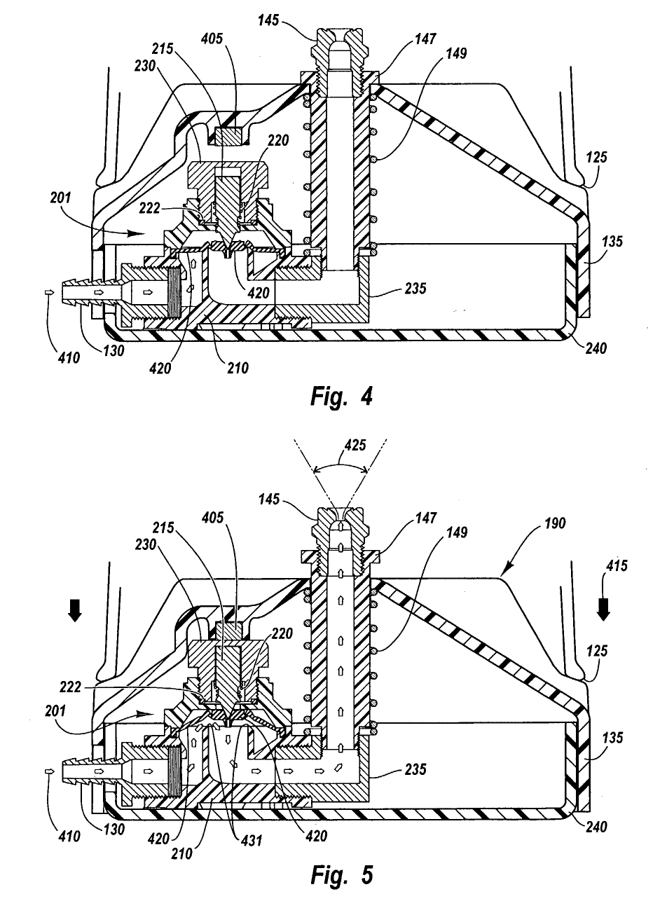

Liquid flowing through supply line 130 flows through the valve housing 210, as regulated by valve assembly 201, and through an elbow 235, which is threadedly coupled to the valve housing 210. A threaded extension section 147 (FIGS. 4 and 5) is threadedly coupled to the elbow 235, which provides a passageway for the liquid to flow to nozzle 145, which is threadedly received by the threaded extension section 147.

The rigid base body 240 comprises, in one embodiment, a plastic material that may be opaque and is resistant to cracking. The base body is configured to correspond to the shape of a standard mixing jar, as shown in FIG. 1, to facilitate rinsing of the jar.

The valve 201 is moveable between an open position and a closed position. The open position allows the pressurized liquid from the supply line 130 to flow through the valve housing 210 and ultimately to the nozzle 145. And the closed position of the valve 401 prevents liquid from flowing through the valve housing 210. FIGS. 4 and 5 show the operation of the valve assembly 201. The metal pin 215 interfaces with a magnet 405 held in a recess formed on the under side of the base cover 190. The interaction between magnet 405 and metal pin 215 causes the valve 201 to move between the open and closed positions. The coil spring 220 biases the magnetic pin 215 down toward a seat 229 held inside the valve housing 210 to close the valve 210 when no upward force is applied to the pin 215 by magnet 405. The threaded cap 230 which holds the metal pin 215 inside valve housing 210 comprises a non-magnetic material that allows the magnet 405 to act upon pin 215 without interference.

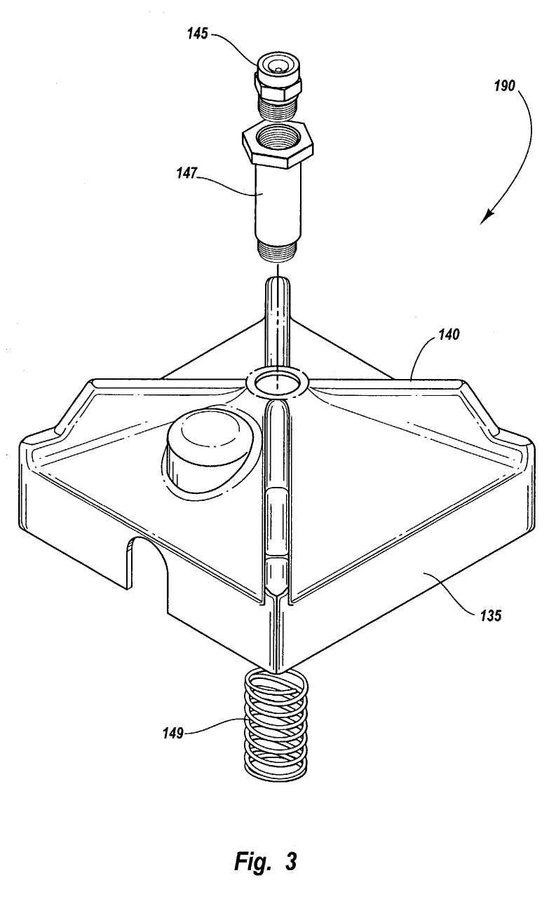

FIG. 3 illustrates an exploded view of the presently preferred embodiment of the base cover. The ridges or flanges 140 extend upward from the rigid cover body 135 and facilitate engagement with various shapes of containers. The nozzle manifold or extension piece 147 secures the base cover 135 to the base 240. A coil spring 149 is positioned over the extension piece 147 to bias the base cover 190 relative to the base 200. The nozzle 145 is connected to the extension piece 147 and thus does not move when the cover 190 is urged toward the base 200 to overcome the spring bias and actuate the valve 201. The nozzle 145 is connected to the extension piece 147 and thus does not move when the cover 190 is urged toward the base 200 to overcome the spring bias and actuate the valve 201.

FIGS. 4 and 5 illustrate cutaway views of the entire presently preferred embodiment of the rinsing apparatus illustrating the extended and retracted position of the base cover in relation to the base. FIG. 4 illustrates the extended position of the base cover 190 wherein the valve 210 is in the closed position. The valve assembly 201 further includes a rubber diaphragm or disk 420 secured inside the valve housing 210 as shown in FIGS. 4 and 5. The spring 149 positioned over the nozzle manifold 147 biases the base cover 190 away from the base body 240. A magnet 405 is held in a recess formed in the wall 135 of base cover 190. When the base 190 is biased away from the base body 240, the magnet has no affect on the metal pin 215. The pin 215 therefore settles downward by gravity and into a seat formed in the rubber disk 420 to force the rubber disk 420 downward and close the valve 201. In this position, the disk bears against upstanding edges 431 of the valve passageway to prevent pressurized liquid from flowing through valve 201.

FIG. 5 illustrates the base cover 190 urged toward the base 240 to open the valve 201. A downward force 415 is exerted on to the rinsing apparatus 100 with the top edges 125 of a container. The downward force 415 overcomes the bias force of spring 149 and causes the base body 135 to move downwardly relative to the base body 240. In this position, the magnet 405 exerts an upward magnetic pulling force upon the pin 215 because of its close proximity to the pin 215. The magnetic force passes through the cap 230 pulling the pin 215 upward and overcoming the bias of coil spring 220. When the pin 215 is retracted away from the rubber disk 420, the pressurized liquid 410 urges the disk 420 upward, and is able to pass through the valve and to the nozzle 145.

The nozzle 145 is shaped to spray the pressurized liquid at a particular spray angle 425. In one embodiment, the spray is at a 120-degree angle.

FIG. 6 illustrates a perspective view of a blender jar 150 being rinsed by the rinsing apparatus 100 of the present invention. In FIG. 6, the blender jar is positioned so that the corners of the jar are aligned with ridges 140. Only the top surfaces at the corners of jar 150 engage the base cover 190 at engagement areas 137. This minimizes contact between the base cover 190 and the jar 150. Upon actuation, liquid is sprayed via nozzle 145 to rinse the interior surface of the blender jar 150. The liquid subsequently flows out of the open end of the blender jar 150, over the base cover 190 of the rinsing apparatus 100, and subsequently to a drain (not shown).

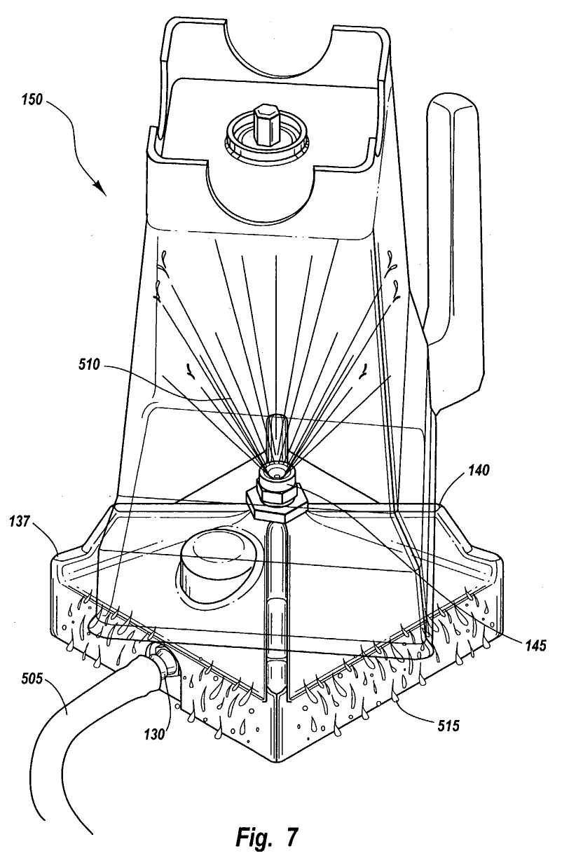

FIG. 7 shows an alternative embodiment of a blender jar 150 being rinsed, where the blender jar is positioned so that the corners of jar 150 are between ridges 140. In this embodiment, only small areas of the top edges of the blender jar 150 contact the base cover 190. In this alternative actuating configuration, the pressurized liquid flowing through nozzle 145 is still able to rinse the entire interior surface of the blender jar 150. Thereafter, liquid flows out of the open end of the blender jar 150, and over the base cover 190 of the rinsing apparatus 100 to a drain (not shown).

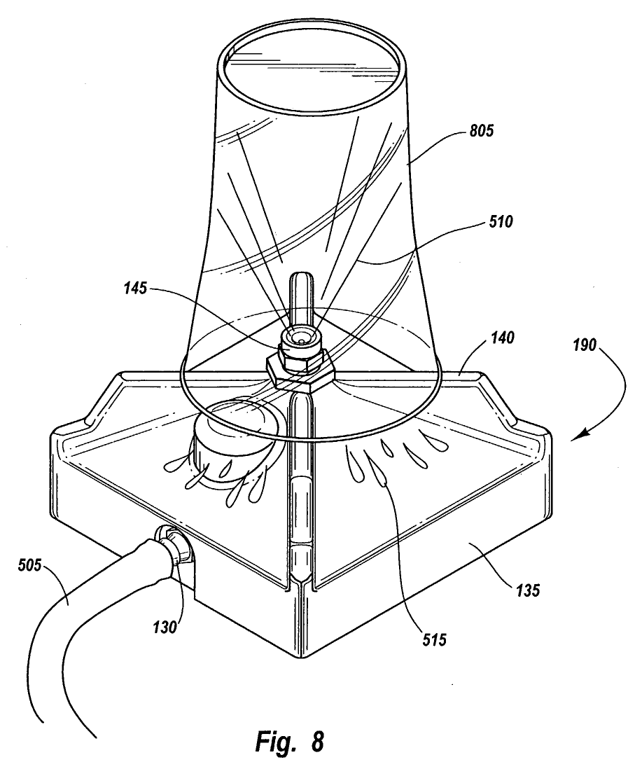

FIG. 8 shows a cylindrical container being rinsed by the presently preferred embodiment of the rinsing apparatus. As FIG. 8 illustrates, almost any size or shape of container can be rinsed or cleaned using the rinsing apparatus of the present invention. The top edge of the cylindrical container 805 depresses flanges 140 of the base cover 190 to thereby move the valve into the open position and allowing pressurized liquid to flow out the nozzle 145. The pressurized liquid rinses out the interior surface of the cylindrical container 805 and flows out the open top end of the cylindrical container 805 as shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. The words “including” and “having,” as used in the specification, including the claims, shall have the same meaning as the word “comprising.”

1. A rinsing apparatus comprising:
a base including a valve and nozzle, wherein the valve is moveable between an open position and a closed position, and wherein the open position allows a liquid to flow out the nozzle and the closed position prevents the liquid from flowing out the nozzle; and
a base cover connected with the base, the base cover being moveable between an extended position and a retracted position, wherein the extended position of the base cover corresponds to the closed position of the valve and the retracted position of the base cover corresponds to the open position of the valve, and wherein the retracted position of the base cover is achieved by depressing a top surface of a container onto the base cover.

2. The rinsing apparatus of claim 1 wherein the nozzle extends through the base cover.

3. The rinsing apparatus of claim 1 wherein the base further comprises an inlet that is configured to receive a pressurized liquid and transfer the liquid to the valve.

4. The rinsing apparatus of claim 1 wherein the base further comprises at least one suction device configured to removably mount the rinsing apparatus onto a surface.

5. The rinsing apparatus of claim 1 wherein the base further comprises a rigid base body.

6. The rinsing apparatus of claim 5 wherein the valve is mounted to the rigid base body with at least one fastener.

7. The rinsing apparatus of claim 1 wherein the base cover further comprises a rigid cover body.

8. The rinsing apparatus of claim 1 wherein the base cover further includes a magnet that is configured to interface with the valve to move the valve into the open position when the base cover is in the retracted position.

9. The rinsing apparatus of claim 1 further comprising a bias mechanism, the bias member urging the base cover in the extended position away from the base.

10. The rinsing apparatus of claim 1 wherein the base cover further comprises a plurality of flanges extending upwardly from the base cover, and wherein the flanges facilitate receiving a container on the base cover.

11. The rinsing apparatus of claim 1 wherein the nozzle sprays liquid at a 120-degree spray angle.

12. The rinsing apparatus of claim 1 wherein the valve comprises a magnetically actuated switch such that when the base cover is depressed into the retracted position, the magnetically actuated switch causes the valve to move into the open position.

13. The rinsing apparatus of claim 1 wherein the liquid is water.

14. The rinsing apparatus of claim 1 wherein the rinsing apparatus is capable of completely rinsing the container in less than five seconds.

15. A container rinsing apparatus comprising:
a rinsing apparatus configured to receive a container to be rinsed;
a nozzle coupled to the rinsing apparatus, the nozzle configured to spray water in a three dimensional area;
a valve being moveable between an open position and a closed position, wherein the open position allows water to flow out the nozzle and the closed position restricts water from flowing out the nozzle; and
an actuator operatively coupled to the valve, the actuator positioning the valve in the open position when a top edge of a container engages the rinsing apparatus.

16. The container rinsing apparatus of claim 15 wherein the container rinsing apparatus farther includes a supply line that receives pressurized liquid and transfers the liquid to the valve.

17. The container rinsing apparatus of claim 15 wherein the nozzle is configured to spray liquid at a 120-degree spray angle.

18. The container rinsing apparatus of claim 15 wherein the liquid is water.

19. The container rinsing apparatus of claim 15 wherein the actuator is a magnet.

20. A container rinsing apparatus comprising:
a base including a valve and nozzle, wherein the valve is moveable between an open position and a closed position, and wherein the open position allows liquid to flow out of the nozzle and the closed position prevents liquid from flowing out the nozzle;
a base cover connected with the base, the base cover being moveable between an extended position and a retracted position, wherein the extended position of the base cover corresponds to the closed position of the valve and the retracted position of the base cover corresponds to the open position of the valve; and
a container having an open end and closed end, wherein the open end of the container engages the base cover;
wherein the nozzle is closer to the open end as compared to the closed end when the container engages the base cover.

21. The container rinsing apparatus of claim 20 wherein the nozzle extends through the base cover.

22. The container rinsing apparatus of claim 20 wherein the base further includes an inlet configured to receive a pressurized liquid and transfer the liquid to the valve.

23. The container rinsing apparatus of claim 20 wherein the base further comprises at least one suction device configured to removably mount the container rinsing apparatus onto a surface.

24. The container rinsing apparatus of claim 20 wherein the base further comprises a rigid base body.

25. The container rinsing apparatus of claim 24 wherein the valve is mounted to the rigid base body with at least one fastener.

26. The container rinsing apparatus of claim 20 wherein the base cover further comprises a rigid cover body.

27. The container rinsing apparatus of claim 20 wherein the base cover further comprises a magnet that is configured to interface with the valve to move the valve into the open position when the base cover is depressed into the retracted position.

28. The container rinsing apparatus of claim 20 wherein the base cover further comprises a bias member positioned between the base and the base cover to urge the base cover away from the base in the extended position when no downward pressure is applied to the base cover.

29. The container rinsing apparatus of claim 20 wherein the base cover further comprises a plurality of flanges that extend upwardly from the base cover relative to the base to accommodate the open end of the container.

30. The container rinsing apparatus of claim 20 wherein the nozzle sprays liquid at a 120-degree spray angle.

31. The container rinsing apparatus of claim 20 wherein the valve utilizes a magnetic switch, and wherein when the base cover is depressed into the retracted position, a magnet on the base cover causes the valve to move into the open position.

32. The container rinsing apparatus of claim 20 wherein the liquid is water.

33. The container rinsing apparatus of claim 20 wherein the rinsing apparatus is capable of rinsing a blender jar in less than five seconds.

34. A method of rinsing a container comprising the acts of:
providing a rinsing device having a base cover;
providing a container;
engaging the base cover with the container to open a valve and allow pressurized liquid to be introduced into the container to rinse the container.

35. The method of claim 34, further comprising:
providing a plurality of ridges on the base cover;
aligning the container with the ridges upon engaging the container with the base cover.

36. The method of claim 34, further comprising:
maintaining the engagement between the container and the base cover for a period of time sufficient to rinse interior of the container.

37. The method of claim 34, further comprising:
providing a plurality of ridges;
wherein the container comprises a plurality of corners;
orienting the corners between the ridges such that only small areas on the top edges of the container contact the ridges when the container engages the base cover.
